(19) United States
(12) Patent Application Publication
(10) Pub. No.: US 2007/0082775 A1
(43) Pub. Date: Apr. 12, 2007

(54) Timing chain drive

(75) Inventors: Renzo Perissinotto, Dachau (DE); Thomas Englbrecht, Anzing (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: JOH. WINKLHOFER & SOHNE GMBH UND CO. KG, Munchen (DE)

(21) Appl. No.: 11/542,443

(22) Filed: Oct. 3, 2006

(30) Foreign Application Priority Data
Oct. 12, 2005 (DE) 102005048858.7

(51) Int. Cl. F16H 7/08; F16H 7/18

(52) U.S. Cl. 474/111; 474/140

(57) ABSTRACT

The present invention relates to a timing chain drive for an internal combustion engine, comprising a crankshaft sprocket and at least one camshaft sprocket, a chain which is wrapped around these two sprockets, and a tensioning device, said tensioning device comprising a pivotable tensioner blade and a chain tightener which presses said tensioner blade against the chain, the tensioner blade being adapted to be moved, by means of the chain tightener, between a position of minimum tensioning and a position of maximum tensioning, when the timing chain drive is in operation, and being adapted to be moved to a mounting position in the assembled or disassembled condition of the chain tightener, characterized in that, on the side facing the chain tightener, the tensioner blade is provided with a projection which rests on the engine in the mounting position and which is of such a nature that the chain is maintained in a position of safe engagement.

### CROSS-REFERENCE TO RELATED APPLICATION

The present application claims the benefit of priority of European Patent Application No. 10 2005 048 858.7 filed on Oct. 12, 2005. The entire text of the priority application is incorporated herein by reference in its entirety.

### FIELD OF THE DISCLOSURE

The present disclosure relates to a timing chain drive for a combustion engine, with a crankshaft sprocket and at least one camshaft sprocket, a chain which is wrapped around these two sprockets, and a tensioning device, the tensioning device comprising a pivotable tensioner blade and a chain tightener which presses said tensioner blade against the chain, the tensioner blade being adapted to be moved, by means of the chain tightener, between a position of minimum tensioning and a position of maximum tensioning, when the timing chain drive is in operation, and being adapted to be moved to a mounting position in the assembled or disassembled condition of the chain tightener.

### BACKGROUND OF THE DISCLOSURE

Timing chain drives are used for internal combustion engines in the prior art. They transmit a movement from the crankshaft sprocket to the camshaft sprocket and vice versa. The timing chain drive is in engagement with both sprockets. The camshaft sprocket controls the movement of the valves via a camshaft. In the prior art it is known to use tensioner blades so that the timing chain remains in engagement with the sprockets. The tensioner blades are articulated on a pivotal point which is affixed to an engine block of the internal combustion engine. The tensioner blade is adapted to be pivoted about this pivotal point. For pivoting the tensioner blade, a chain tightener, which is hydraulically operable, is often used in the prior art. In addition to hydraulically operable chain tighteners, which consist of a cylinder in the interior of which a piston can be moved through hydraulically generable pressures, also spring-biased hydraulic piston/cylinder devices are used as chain tighteners,

A timing chain drive is a critical subassembly, since, in the case of maintenance work, problems may arise when the chain tightener is removed and when a new or a repaired chain tightener is reinstalled. If a chain tightener is simply removed and if the timing chain is displaced, the valve control points will shift. This has the effect that the intake and exhaust movements of the valves are no longer in harmony with the movements of a piston included in the internal combustion engine. It goes without saying that also the movement of a plurality of pistons, which may perhaps be provided, will then no longer be in harmony with the valve movements. It follows that, during maintenance work, it is particularly important that the matching of the timing chain and the camshaft sprocket can be reconstituted or that the matching is maintained.

### SUMMARY OF THE DISCLOSURE

It is the object of the present disclosure to achieve an improvement in this respect.

This object is achieved in that, on the side facing the chain tightener, the tensioner blade is provided with a projection which rests on the engine in the mounting position and which is of such a nature that the chain is maintained in a position of safe engagement.

The tensioner blade is articulated such that it is pivotable about the pivotal point. The pivotal movement is caused by the chain tightener. The chain tightener consists of a cylinder and a piston, the piston being adapted to be moved in the cylinder by means of oil pressure and/or spring tension. The movement of the piston causes a pivotal movement of the tensioner blade.

The chain tightener can be extended up to a position of maximum tensioning. At this position of maximum tensioning a maximum tension is obtained in the timing chain. The timing chain is located at a maximum distance from the cylinder of the chain tightener. This is one of the operating conditions. In addition to this maximum tensioned operating condition, there is also a minimum tensioned operating condition, viz. the position of minimum tensioning. At this position, the piston of the chain tightener is extended to a lesser extent from the cylinder of the chain tightener. The initial tension on the tensioner blade is now not quite as strong as it was at the position of maximum tensioning. In addition, the distance between the timing chain and the chain-tightener cylinder, which is attached to the engine block, is shorter than at the position of maximum tensioning.

If in the case of mounting, i.e. when the chain tightener is assembled or disassembled, the initial tension of the timing chain is reduced still further, so that the tension prevailing in the timing chain will hardly exceed the tension caused by the net weight force of the timing chain, a position of safe engagement will be achieved in this condition, which is not an operating condition. At this position of safe engagement, at which the chain tightener is displaced by the nominal length, the tensioner blade rests via a projection on an element which is fixedly connected to the engine block—possibly even directly on the engine block—and prevents a further decrease of the initial tension in the timing chain. This will guarantee that the timing chain remains in engagement with the sprockets. The chain will be prevented from slipping off or bouncing off the sprockets. A shifting of the valve opening and valve closing times with regard to the crankshaft sprocket and the pistons contained in the combustion cylinders will be avoided.

A service technician who executes maintenance work will now be able to carry out his work, in particular to replace the chain tightener, without any complicated safety and marking operations being necessary on the chain, the sprockets, the chain tightener and/or the engine block.

According to one further embodiment, it will be of advantage when the projection is formed of the same material as the tensioner blade. The tensioner blade can be formed at a reasonable price and in a time-saving manner in one production step; this has the effect that the projection will be formed simultaneously with the tensioner blade.

In order to achieve a particularly high durability, it will be advantageous when, according to another embodiment, the tensioner blade and the projection are formed of one component. The tension gradients in the tensioner blade and in the projection will then be better than in cases where a separate projection element is secured to the tensioner blade.

The tensioner blade can be produced at a particularly reasonable price, when it is, in accordance with one embodiment, formed of plastic material, preferably of fiber-reinforced plastic material.

Since the present disclosure does not aim at preventing a so-called starting chatter, it will also be unnecessary to assign additional damping properties to the projection. Hence, the costs will be reduced in an advantageous manner, when the material of the projection does not have any damping properties. Material fatigue of the projection will additionally be avoided.

In order to prevent premature wear of the tensioner blade in the operating condition, it will be of advantage, when, according to one embodiment, the tensioner blade is provided with a sliding coating on which the chain is guided.

When the sliding coating is integrated with a tensioner blade coating which is applied to the tensioner blade, the sliding coating can, in the case of maintenance work on the tensioner blade, be replaced particularly easily by applying a new sliding coating to the tensioner blade. One possible mode of application is clipping on.

When the projection has a length in the direction of the longitudinal axis through the chain tightener which prevents the tensioner blade from moving from the position of minimum tensioning beyond the position of safe engagement and which is smaller than one third of the maximum displacement length/displacement path of the piston between the position of minimum tensioning and the position of maximum tensioning, it will be less difficult to prevent a superfluous consumption of material. The material used for the tensioner blade and the projection can then be used more purposefully. This will reduce the weight of the tensioner blade, whereby an unnecessary load on the engine and the vehicle accommodating the engine will be avoided and whereby an unnecessary increase in fuel consumption will be prevented.

According to one embodiment, particularly advantageous proportions will be obtained when, in the position of safe engagement, the ratio of the distance between the tensioner blade and a chain-tightener reference point, which is affixed to the engine, to a minimum displacement length is smaller than or equal to approx. 0.7.

It will also be particularly advantageous, when the modulus of elasticity of the projection is lager than or equal to approx. 0.01 GPa, or preferably larger than or equal to approx. 0.1 GPa, or further preferably larger than or equal to approx. 1 GPa. This modulus of elasticity leads to a projection having essentially no restoring properties, and this will guarantee a long fatigue-proof use of the tensioner blade and of the projection integrated therewith.

When the ratio of the distance between the position of safe engagement and the position of minimum tensioning to the distance between the position of minimum tensioning and the position of maximum tensioning does not exceed 0.5, this will be advantageous for a further embodiment, since unnecessary shifting of the tensioner blade can be avoided.

In the case of a particularly advantageous embodiment, the distance between the position of safe engagement and the position of minimum tensioning is not longer than 5 mm, and preferably not longer than approx. 3 mm. This is particularly advantageous, since optimum lever ratios will thus prevail ithe tensioner blade.

### BRIEF DESCRIPTION OF THE DRAWINGS

In the following, embodiments will be explained in more detail on the basis of a drawing, in which

FIG. 1 shows a schematic side view of a chain tightener, which moves a tensioner blade between three extreme positions, the timing chain being shown in a condition in which it slides over the sliding surface of the tensioner blade at a position of maximum tensioning, a position of minimum tensioning and a position of safe engagement,

### DETAILED DESCRIPTION OF THE DISCLOSURE

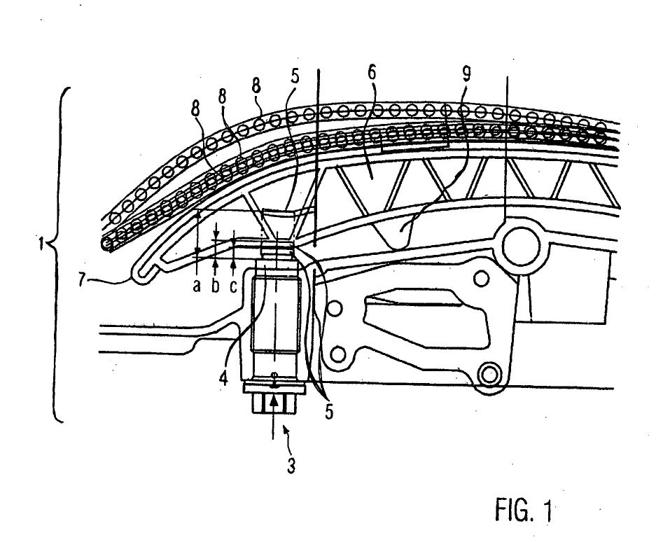

FIG. 1 shows a detail of a timing chain drive. The timing chain drive is attached to the engine block of an internal combustion engine 2. The engine block or an element of the internal combustion engine 2 that is affixed to the engine block has secured thereto a chain tightener 3. The chain tightener 3 is provided with a cylinder 4 which is screwed into the engine block of the internal combustion engine 2 or into the element which is affixed to said internal combustion engine 2. A piston 5 is displaceably supported in the cylinder 4 of the chain tightener 3. The piston 5 is adapted to be moved through oil pressure and/or spring pressure.

Chain tighteners 3 are known, which comprise in the interior of the cylinder 4 a spring as well as an oil reservoir which is adapted to have pressure applied thereto from outside through oil. The piston 5 is adapted to be extended through this application of pressure. The piston 5 can be brought into non-positive and/or positive operative engagement with a tensioner blade 6. The tensioner blade 6 is articulated on a pivotal point which is affixed to the engine block and which is not shown. The tensioner blade 6 is adapted to be pivoted about this pivotal point. The pivotal movement is caused by the piston 5 of the chain tightener 3.

The tensioner blade 6 is provided with a sliding coating 7 on the side located opposite the chain tightener 3. The sliding coating 7 is made of a wear-resistant material. The tensioner blade 6 is produced from a plastic material with high loading capacity. In the present embodiment, the tensioner blade 6 is produced from fiber-reinforced plastic material and provided with a separate clip-on tensioner blade coating. The tensioner blade coating defines the sliding coating 7.

On the side of the sliding coating 7 that faces away from the tensioner blade 6, a timing chain 8 slides.

In the installed or non-installed condition, which does not represent the operating condition, the piston 5 is removed from the engine block or it has not yet been fully installed therein so that the spring in the interior of the chain tightener 3 will fully extend piston 5 without moving the tensioner blade 6 and consequently the chain 8 away from the position of safe engagement. The extension movement of the piston 5 is caused only by the spring in the interior of the chain tightener 3. A distance which characterizes the position of safe engagement results between the tensioner blade 6 and a reference point that is affixed to the engine.

The distance between the point where the piston 5 contacts the tensioner blade 6 and the upper edge of the cylinder 4 of the chain tightener 3, which represents the reference point that is affixed to the engine, is the distance c.

In the fully installed condition of the chain tightener 3, the spring pushes the piston 5, the tensioner blade 6 and the timing chain 8 to the position of minimum tensioning.

Like the position of safe engagement, the position of minimum tensioning is indicated in the position of the piston 5 as well as in the position of the timing chain 8. A distance b results between the point where the tensioner blade 6 contacts the piston 5 and the upper edge of the cylinder 4. This distance b is the position of minimum tensioning. The length is referred to as a.

If the piston 5 has pressure applied thereto up to a maximum value, e.g. via oil supplied thereto, said piston 5 will move out of the cylinder 4 of the chain tightener 3 up to a maximum displacement length and it will force the tensioner blade 6 into a position of maximum tensioning, as can be seen in FIG. 1.

In FIG. 1, a projection 9 is provided on the right-hand side of the chain tightener 3 on the side of the tensioner blade 6 that faces the chain tightener. Said projection 9 can be provided, at an almost arbitrary position, on the tensioner blade side facing the chain tightener 3. The projection 9 is produced from the same plastic material as the tensioner blade 6. It does not have any damping properties.

The position of safe engagement is characterized in that the projection 9 abuts on an element of the internal combustion engine 2 which is affixed to the engine block. The projection 9 is implemented as a stop. It prevents the tensioner blade 6 from moving further in the direction of the engine block of the internal combustion engine 2 so that the timing chain 8 cannot be relieved still further. A minimum initial tension of the timing chain 8 will therefore remain. This minimum distance of the position of safe engagement will be maintained even if the chain tightener is removed from the engine block of the internal combustion engine 2, e. g. by unscrewing the cylinder 4 of the chain tightener 3 from the internal combustion engine 2.

A subsequent renewed screwing in of the chain tightener or of a new chain tightener 3 will therefore easily be possible. The timing chain is prevented from coming out of engagement with the crankshaft sprocket or the camshaft sprocket, said sprockets being not shown.

The tensioner blade assumes three extreme positions, which have already been described as position of maximum tensioning, position of minimum tensioning and position of safe engagement. At these positions, the point of contact between the piston 5 and the tensioner blade 6 is located at three different distances from the reference point that is affixed to the engine. The distance which results in the case of the maximum tensioning position is the maximum displacement length a. The distance which results in the case of the minimum tensioning position is the minimum displacement length b. The distance which results in the case of the position of safe engagement is the safe engagement length c. This safe engagement length is shorter than the minimum displacement length which is, in turn, shorter than the maximum displacement length.

The lengths a, b, c are defined parallel to the longitudinal orientation along a longitudinal axis through the chain tightener 3.

We claim:

1. A timing chain drive (1) for a combustion engine (2), comprising a crankshaft sprocket and sprocket, at least one camshaft sprocket, a chain (8) which is wrapped around the crankshaft sprocket and at least one camshaft sprocket, a tensioning device, the tensioning device having a pivotable tensioner blade (6) and a chain tightener (3) which presses the tensioner blade (6) against the chain (8), the tensioner blade (6) being adapted to be moved, by the chain tightener (3), between a position of minimum tensioning and a position of maximum tensioning when the timing chain drive is in operation, and being adapted to be moved to a mounting position in the assembled or disassembled condition of the chain tightener (3) and, on the side facing the chain tightener (3), the tensioner blade (6) is provided with a projection (9) which rests on the engine (2) in the mounting position and in which the chain is maintained in a position of safe engagement.

2. A timing chain drive according to claim 1, wherein the projection (9) is formed of the same material as the tensioner blade (6).

3. A timing chain drive (1) according to claim 1, wherein the tensioner blade (6) and the projection (9) are integrally formed with one another.

4. A timing chain drive (1) according to claim 1, wherein the tensioner blade (6) is formed of plastic material.

5. A timing chain drive (1) according to claim 1, wherein the material forming the projection (9) does not have any damping properties.

6. A timing chain drive (1) according to claim 1, wherein the tensioner blade (6) is provided with a sliding coating (7) on which the chain (8) is guided.

7. A timing chain drive (1) according to claim 1, wherein the sliding coating (7) is attached to a tensioner blade coating which is applied to the tensioner blade (6).

8. A timing chain drive (1) according to claim 1, wherein the projection (9) has a length in the direction of the longitudinal axis through the chain tightener (3) which prevents the tensioner blade (6) from moving from the position of minimum tensioning beyond the position of safe engagement and which is smaller than one third of the maximum displacement length.

9. A timing chain drive (1) according to claim 1, wherein in the position of safe engagement, the ratio of the distance between the tensioner blade (6) and a chain-tightener reference point, which is affixed to the engine, to a minimum displacement length, is one of smaller than or equal to approx. 0.7.

10. A timing chain drive (1) according to claim 1, wherein the modulus of elasticity of the projection (9) is one of lager than or equal to approximately 0.01 GPa.

11. A timing chain drive (1) according to claim 1, wherein the ratio of the distance between the position of safe engagement and the position of minimum tensioning to the distance between the position of minimum tensioning and the position of maximum tensioning does not exceed approximately 0.5.

12. A timing chain drive (1) according to claim 1, wherein the distance between the position of safe engagement and the position of minimum tensioning is not larger than approximately 5 mm.

13. A timing chain drive (1) according to claim 4, wherein the plastic material is fiber-reinforced.

14. A timing chain drive (1) according to claim 10, wherein the modular of elasticity of the projection (9) is one of larger than or equal to approximately 0.1 GPa.

15. A timing chain drive (1) according to claim 10, wherein the modular of elasticity of the projection (9) is one of larger than or equal to approximately 1 GPa.

16. A timing chain drive (1) according to claim 12, wherein the distance is not larger than approximately 3 mm.
